(19) United States
(12) Patent Application Publication
(10) Pub. No.: US 2025/0157097 A1
(43) Pub. Date: May 15, 2025

(54) X-RAY CT APPARATUS, PROGRAM, AND INFORMATION PROCESSING METHOD

(71) Applicants: HOYA CORPORATION, Tokyo (JP); SHIMADZU CORPORATION, Kyoto (JP)

(72) Inventors: Akihiko NISHIDE, Tokyo (JP); Kazunori ODANI, Kyoto (JP); Taketo KISHI, Kyoto (JP)

(73) Assignees: HOYA CORPORATION, Tokyo (JP); SHIMADZU CORPORATION, Kyoto (JP)

(21) Appl. No.: 18/944,871

(22) Filed: Nov. 12, 2024

(30) Foreign Application Priority Data
Nov. 13, 2023 (JP) 2023-193022

(51) Int. Cl. G06T 11/00

(52) U.S. Cl. CPC G06T 11/005; G06T 2207/10081; G06T 2211/408

(57) ABSTRACT

X-ray CT apparatus including an X-ray generation device and an X-ray detector that detects an X-ray emitted from the X-ray generation device and passing through an inspection object, and collecting X-ray projection data of at least two types of X-ray energies to reconstruct a dual energy image, the X-ray CT apparatus further includes: an acquisition unit that acquires inspection object information including a physical quantity and physical property information of the inspection object, and X-ray characteristic information of an X-ray spectrum, an X-ray filter, and the X-ray detector; and an X-ray imaging condition determination unit that determines X-ray imaging conditions for collecting X-ray projection data of the at least two types of X-ray energies emitted from the X-ray generation device, on the basis of the inspection object information and the X-ray characteristic information of the X-ray spectrum, the X-ray filter, and the X-ray detector acquired by the acquisition unit.

### BACKGROUND

### Technical Field

The present technology relates to an X-ray CT apparatus, a program, and an information processing method.

### Related Art

There is known an X-ray CT apparatus configured to be able to perform dual energy imaging in which imaging is performed while switching an X-ray tube voltage between a low voltage (for example, 80 kV) and a high voltage (for example, 140 kV) by one X-ray tube during scanning, dual energy imaging in which imaging is performed simultaneously at a low X-ray tube voltage (for example, 80 kV) and a X-ray tube voltage (for example, 140 kV) by two X-ray tubes, dual energy imaging in which a low X-ray energy component and a high X-ray energy component are collected by a two-layer X-ray detector, and dual energy imaging in which a low X-ray energy component and a high X-ray energy component are discriminately collected by a semiconductor X-ray detector.

However, the X-ray CT apparatus disclosed in JP 2012-100913 A does not consider that the X-ray imaging condition of dual energy imaging is more optimally determined according to different types of objects (inspection objects) to be scanned. The meaning of more optimally may include making the ratio (dual energy ratio) of the X-ray absorption coefficients of the subject at a low voltage and a high voltage of the X-ray tube voltage larger and making the SN ratio at the low voltage and the high voltage of the X-ray tube voltage as equal as possible in consideration of the quality of X-rays output from the X-ray tube and passing through an X-ray filter and the energy detection distribution of the X-ray detector. However, in a case where there is a bow-tie filter that controls distribution of emitted X-rays in the channel direction of the imaging visual field, the X-ray filter may include the bow-tie filter.

In one aspect, an object of the present invention is to provide an X-ray CT apparatus and the like capable of more optimally determining an X-ray imaging condition of dual energy imaging according to an inspection object which is an object to be scanned.

### SUMMARY

An X-ray CT apparatus according to one aspect of the present disclosure including an X-ray generation device, and an X-ray detector configured to detect an X-ray emitted from the X-ray generation device and passing through an inspection object, and collecting X-ray projection data of at least two types of X-ray energies to reconstruct a dual energy image, the X-ray CT apparatus further includes: an acquisition unit configured to acquire inspection object information including a physical quantity and physical property information of the inspection object, and X-ray characteristic information of an X-ray spectrum, an X-ray filter, and the X-ray detector; and an X-ray imaging condition determination unit configured to determine each of X-ray imaging conditions for collecting X-ray projection data of at least two types of X-ray energies emitted from the X-ray generation device, on a basis of the inspection object information and the X-ray characteristic information of the X-ray spectrum, the X-ray filter, and the X-ray detector acquired by the acquisition unit.

The X-ray CT apparatus includes an X-ray filter, and a plurality of density tomographic images such as a monochromatic tomographic image, a water density tomographic image, and an iodine density tomographic image of each keV (effective energy) are reconstructed by reconstructing the dual energy image.

A program according to one aspect of the present disclosure causes a computer to execute a process including: acquiring inspection object information including a physical quantity and physical property information of an inspection object to be an object to be inspected by X-rays of at least two types of X-ray energies emitted from an X-ray generation device, and X-ray characteristic information of an X-ray spectrum, an X-ray filter, and an X-ray detector; and determining each of X-ray imaging conditions for collecting X-ray projection data of the at least two types of X-ray energies emitted from the X-ray generation device, on the basis of the inspection object information and the X-ray characteristic information of the X-ray spectrum, the X-ray filter, and the X-ray detector that have been acquired.

An information processing method according to one aspect of the present disclosure causes a computer to execute a process including: acquiring inspection object information including a physical quantity and physical property information of an inspection object to be an object to be inspected by X-rays of at least two types of X-ray energies emitted from an X-ray generation device, and X-ray characteristic information of an X-ray spectrum, an X-ray filter, and an X-ray detector; and determining each of X-ray imaging conditions for collecting X-ray projection data of the at least two types of X-ray energies emitted from the X-ray generation device, on the basis of the inspection object information and the X-ray characteristic information of the X-ray spectrum, the X-ray filter, and the X-ray detector that have been acquired.

According to the present disclosure, it is possible to provide the X-ray CT apparatus and the like capable of more optimally determining an X-ray imaging condition of dual energy imaging according to an inspection object which is an object to be scanned. The meaning of more optimally may include making the ratio (dual energy ratio) of the X-ray absorption coefficients of the subject at a low voltage and a high voltage of the X-ray tube voltage larger and making the SN ratio at the low voltage and the high voltage of the X-ray tube voltage as equal as possible in consideration of the quality of X-rays output from the X-ray tube and passing through an X-ray filter and the energy detection distribution of the X-ray detector. However, in a case where there is a bow-tie filter that controls distribution of emitted X-rays in the channel direction of the imaging visual field, the X-ray filter may include the bow-tie filter.

### BRIEF DESCRIPTION OF DRAWINGS

FIG. 1 is a schematic diagram illustrating an outline of an X-ray CT apparatus according to a first embodiment;

FIG. 2 is an explanatory diagram illustrating rotation of an X-ray generation device and a two-dimensional X-ray detector;

FIG. 3 is a functional block diagram exemplifying functional units included in the X-ray CT apparatus (central processing unit);

FIG. 4 is a flowchart illustrating a schematic operation of the X-ray CT apparatus;

FIG. 5 is a flowchart illustrating details of data collection in the schematic operation of the X-ray CT apparatus;

FIG. 6 is a flowchart illustrating details of determination (simulation) of an X-ray imaging condition in data collection of the X-ray CT apparatus;

FIG. 7 is a flowchart illustrating details of preprocessing in the schematic operation of the X-ray CT apparatus;

FIG. 8 is a flowchart illustrating three-dimensional back projection processing in the schematic operation of the X-ray CT apparatus;

FIG. 9 is an explanatory diagram illustrating a flow of data processed in image reconstruction by dual energy imaging;

FIG. 10 is a functional block diagram exemplifying functional units included in an X-ray CT apparatus (central processing unit) according to a second embodiment;

FIG. 11 is an explanatory diagram exemplifying an X-ray imaging condition table (lookup table); and

FIG. 12 is a flowchart illustrating details of data collection (lookup table) in the schematic operation of the X-ray CT apparatus.

### DETAILED DESCRIPTION

### First Embodiment

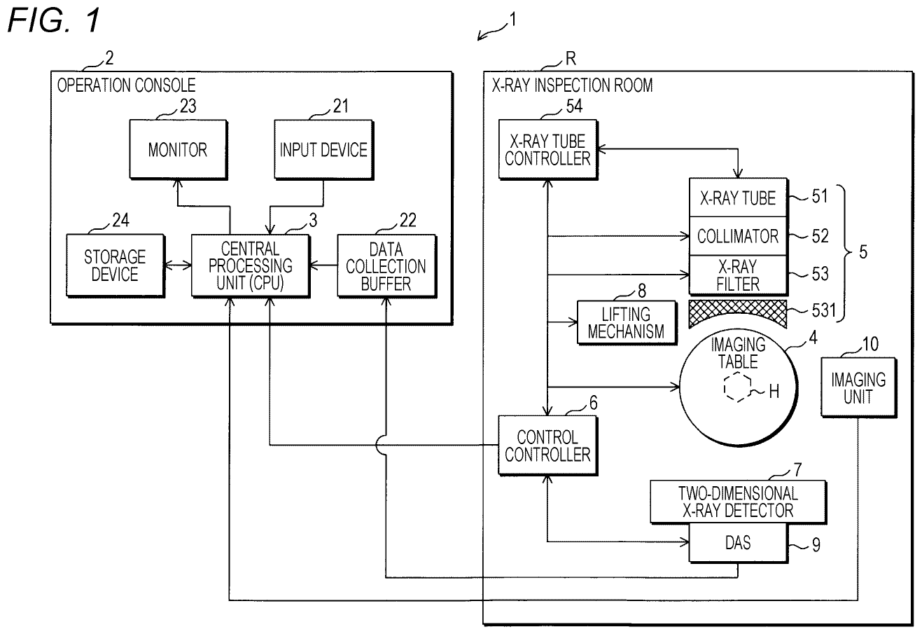

Hereinafter, the present invention will be described in detail with reference to the drawings illustrating embodiments of the present invention. FIG. 1 is a schematic diagram illustrating an outline of an X-ray CT apparatus 1 according to a first embodiment. The X-ray CT apparatus 1 includes an operation console 2, and an imaging table 4, an X-ray generation device 5, a control controller 6, a two-dimensional X-ray detector 7, a lifting mechanism 8, and a data acquisition system (DAS) 9 that are disposed in an X-ray inspection room R. Furthermore, an imaging unit 10 is provided in the X-ray inspection room R, and the imaging unit 10 is communicably connected to the operation console 2 and may be configured as a part of the X-ray CT apparatus 1.

The operation console 2 includes an input device 21, a data collection buffer 22, a monitor 23, a storage device 24, and a central processing unit 3.

The input device 21 may be, for example, an input device of a user operation system such as a keyboard or a mouse, or an input/output I/F of a communication system to which data transmitted from another computer is input.

The data collection buffer 22 is communicably connected to the central processing unit 3 and the data acquisition system 9 disposed in the X-ray inspection room R, and outputs X-ray detector data acquired from the data acquisition system 9 to the central processing unit 3.

The monitor 23 is a display device such as a display. The X-ray detector data is processed by the central processing unit 3, and an image (dual energy image, X-ray dual energy tomographic image) reconstructed from the X-ray detector data into a tomographic image is displayed on the monitor 23.

The central processing unit 3 functions as an image reconstruction unit that reconstructs an X-ray dual energy tomographic image on the basis of X-ray projection data detected by the two-dimensional X-ray detector 7 (X-ray detector) by executing a program stored in the storage device 24.

The storage device 24 includes a volatile storage area such as a static random access memory (SRAM), a dynamic random access memory (DRAM), or a flash memory, and a nonvolatile storage area such as an EEPROM or a hard disk. The storage device 24 stores in advance a program executed by the central processing unit 3 and data to be referred to at the time of processing. The program stored in the storage device 24 may be a program that is read from a recording medium readable by the operation console 2. In addition, the program may be a program that is downloaded from an external computer (not illustrated) connected to a communication network (not illustrated) and is stored in the storage device 24.

The central processing unit 3 includes one or a plurality of arithmetic processing devices having a time counting function, such as central processing units (CPUs), micro-processing units (MPUs), and graphics processing units (GPUs), and performs various types of information processing, control processing, and the like related to the X-ray CT apparatus 1, including processing related to reconstruction of a tomographic image, by reading and executing the program stored in the storage device 24.

The X-ray generation device 5 includes an X-ray tube controller 54, an X-ray tube 51, an X-ray filter 53, a bow-tie filter 531, and a collimator 52, and is configured to enable dual-energy imaging with high energy and low energy by using at least two types of X-ray energies.

The X-ray tube controller 54 is communicably connected to the control controller 6, changes the tube voltage of the X-ray tube 51 on the basis of a control signal and a high voltage output from the control controller 6, and controls start and stop of X-ray emission from the X-ray tube 51. The X-ray tube controller 54 may be configured by, for example, a microcomputer in which a control unit such as a CPU and a storage unit are packaged.

The X-ray tube 51 emits, for example, high-energy X-rays and low-energy X-rays. In each of the X-ray tubes 51 corresponding to the high energy and the low energy, the tube voltage of the X-ray tube 51 is determined on the basis of a control signal and a high voltage from the X-ray tube controller 54.

The X-ray filters 53 are provided corresponding to the high energy and low energy X-ray tubes 51, respectively, and include an X-ray filter 53 through which high-energy X-rays pass and an X-ray filter 53 through which low-energy X-rays pass. The X-ray filter 53 is provided with a filter characteristic variable mechanism that varies the filter characteristic, and the filter characteristic can be changed on the basis of a control signal output from the control controller 6 or the X-ray tube controller 54. The filter characteristic (X-ray filter characteristic) is, for example, a characteristic determined on the basis of the material of the filter and the thickness of the filter (X-ray passing distance). On the basis of the control signal from the control controller 6 or the like, the X-ray filter 53 can be replaced with a filter made of a different material, for example, a lead filter can be replaced with an iron filter or a filter can be replaced with a filter made of the same material and having a different thickness by the filter characteristic variable mechanism provided in the X-ray filter 53. The bow-tie filter 531 changes the X-ray absorption coefficient in the channel direction of the imaging visual field to control distribution of emitted X-rays in the channel direction.

The X-ray quality of the X-ray varies according to the tube voltage value of the X-ray tube 51 or the filter characteristic of the X-ray filter 53, and the X-ray generation device 5 is configured to vary the tube voltage value and the X-ray filter characteristic. Therefore, the X-ray generation device 5 emits high-energy and low-energy X-rays having appropriate quality to the inspection object H, so that dual energy imaging can be efficiently performed.

The collimator 52 includes, for example, a slice thickness direction collimator and a channel direction collimator, and collimates and shapes the X-rays generated from the X-ray tube 51.

The inspection object H is placed on the imaging table 4, and rotates at a predetermined rotation speed according to a control signal output from the control controller 6. When the imaging table 4 rotates, X-rays are emitted over the entire circumference of the inspection object H placed on the imaging table 4. The present embodiment is not limited to a case where the imaging table 4 rotates, and the imaging table 4 may be fixed, and the X-ray generation device 5, the two-dimensional X-ray detector 7, and the data acquisition system 9 may rotate with respect to the imaging table 4. That is, the imaging table 4 and the X-ray generation device 5, the two-dimensional X-ray detector 7, and the data acquisition system 9 may be relatively rotated to emit X-rays over the entire circumference of the inspection object H in the rotation direction.

The lifting mechanism 8 is configured to raise and lower the imaging table 4 or the X-ray generation device 5, the two-dimensional X-ray detector 7, and the data acquisition system 9, and relatively move the imaging table 4 and the X-ray generation device 5, the two-dimensional X-ray detector 7, and the data acquisition system 9 in the vertical direction. The lifting mechanism 8 relatively moves the imaging table 4 and the X-ray generation device 5 and the like in the vertical direction on the basis of a control signal output from the control controller 6. As a result, X-rays can be emitted over the entire region in the vertical direction (height direction) of the inspection object H.

The control controller 6 is communicably connected to the central processing unit 3 of the operation console 2, and controls or drives the X-ray generation device 5, the imaging table 4, the lifting mechanism 8, the two-dimensional X-ray detector 7, and the data acquisition system 9 on the basis of instruction information output from the central processing unit 3. The control controller 6 may be configured by, for example, a microcomputer in which a control unit such as a CPU and a storage unit are packaged.

The two-dimensional X-ray detector 7 includes, for example, a plurality of detector columns (X-ray detector channels). In the two-dimensional X-ray detector 7, the plurality of channels for detecting X-rays transmitted through the inspection object H and collecting X-ray detector data are arrayed in the channel direction along the direction in which the inspection object H is relatively rotated and the column direction along the rotation axis when the inspection object H is rotated.

The data acquisition system 9 collects X-ray detector data from the two-dimensional X-ray detector 7, and outputs the X-ray detector data to the central processing unit 3 via the data collection buffer 22.

The imaging unit 10 is, for example, a camera, and is provided in the X-ray inspection room R, such as above the imaging table 4 so that the entire inspection object H placed on the imaging table 4 is in the imaging range. The imaging unit 10 outputs the captured image data of the inspection object H to the operation console 2 (central processing unit 3). The imaging unit 10 corresponds to an inspection object information acquisition device for acquiring a physical quantity such as a shape or a size of the inspection object H or physical property information such as the material of the inspection object H. The inspection object information acquisition device is not limited to the imaging unit 10 such as a camera, and may be a 3D scanner device or a three-dimensional dimension measuring device. These devices and the like included in the X-ray CT apparatus 1 may exhibit configurations, operation, and functions similar to those of the respective devices and the like of the X-ray CT apparatus described in, for example, JP 5220374 B1, JP 5213016 B1, or JP 2007-20906 A.

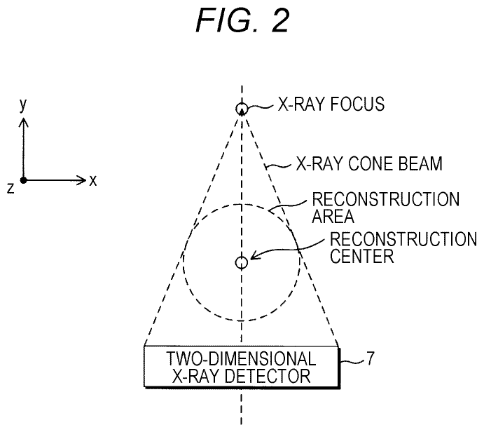

FIG. 2 is an explanatory diagram illustrating rotation of the X-ray generation device 5 and the two-dimensional X-ray detector 7. The X-ray tube 51 and the two-dimensional X-ray detector 7 rotate relative to the imaging table around the rotation center which is the center of the imaging table. When a vertical direction is a Y direction, a horizontal direction is an X direction, and a table traveling direction perpendicular thereto is a Z direction, a rotation plane of the X-ray tube 51 and the two-dimensional X-ray detector 7 is an XY plane.

The X-ray tube 51 generates an X-ray beam called a cone beam. When the center axis direction of the cone beam is parallel to the Y direction, it is assumed that the view angle is 0°. The two-dimensional X-ray detector 7 has, for example, detectors columns of 300 channels×3000 detector columns. In the two-dimensional X-ray detector 7, the plurality of channels for detecting X-rays transmitted through the inspection object H and collecting the X-ray detector data are arrayed in the channel direction along the direction in which the inspection object H is relatively rotated by the imaging table 4 or the like and the column direction along the rotation axis when the inspection object H is rotated.

The X-ray detector data collected by emitting X-rays is A/D converted by the data acquisition system 9 from the two-dimensional X-ray detector 7 and output to the data collection buffer 22. The data input to the data collection buffer 22 is processed by the central processing unit 3, reconstructed into a tomographic image, and displayed on the monitor 23.

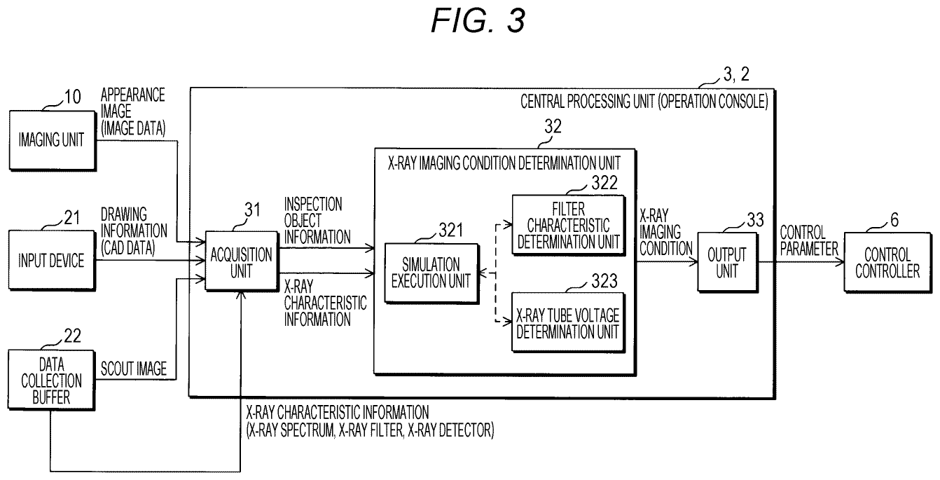

FIG. 3 is a functional block diagram exemplifying functional units included in the X-ray CT apparatus 1 (central processing unit 3). The central processing unit 3 of the X-ray CT apparatus 1 functions as an acquisition unit 31, an X-ray imaging condition determination unit 32, and an output unit 33 by executing a program stored in the storage device 24. The program includes a program module, a subroutine, or the like related to simulation executed by a simulation execution unit 321 to be described later.

The acquisition unit 31 acquires image data of the inspection object H output from the imaging unit 10. Alternatively, the acquisition unit 31 may acquire a physical quantity such as the shape or the size of the inspection object H or physical property information such as the material of the inspection object H input from the operator of the operation console 2 via the input device 21. The physical quantity and the physical property information of the inspection object H may be, for example, in the form of drawing information (three-dimensional CAD data) of the inspection object H, and the acquisition unit 31 may acquire the drawing information of the inspection object H via the input device 21 having the communication system I/F function or a communication device for communicating with another computer. Alternatively, for example, the acquisition unit 31 may acquire a scout image captured as a positioning image from the data collection buffer 22.

The acquisition unit 31 derives the physical quantity such as the shape or the size of the inspection object H and the physical property information such as the material of the inspection object H on the basis of the image data, the drawing information, or the scout image of the inspection object H acquired in this manner, and outputs the derived physical quantity and physical property information to the X-ray imaging condition determination unit 32. For example, the acquisition unit 31 may derive the physical quantity and the physical property information by performing pattern matching on the image of the inspection object H extracted by edge detection on the basis of the image data. Alternatively, the acquisition unit 31 may detect the inspection object H from the image data by using an object detection algorithm having a function of a segmentation network that performs object detection, such as a learning model including regions with convolutional neural network (RCNN), a single shot multibook detector (SSD), you only look once (YOLO), or the like, and derive the physical quantity and the physical property information of the inspection object H. Alternatively, the physical quantity and the physical property information of the inspection object H may be derived by a 3D scanner device or a three-dimensional dimension measuring device.

The acquisition unit 31 further acquires the X-ray characteristic information of the X-ray spectrum, the X-ray filters 53, and the two-dimensional X-ray detector 7 (X-ray detector) from the data collection buffer 22, for example. The acquisition unit 31 outputs the acquired X-ray characteristic information and inspection object information (physical quantity and physical property information of the inspection object) to the X-ray imaging condition determination unit 32.

The X-ray imaging condition determination unit 32 includes the simulation execution unit 321, a filter characteristic determination unit 322, and an X-ray tube voltage determination unit 323, performs simulation by using the X-ray characteristic information and the physical quantity and the physical property information of the inspection object H output by the acquisition unit 31 as input factors, and determines a suitable or more optimal X-ray imaging condition for inspecting the inspection object H. The meaning of more optimal includes making the ratio (dual energy ratio) of the X-ray absorption coefficients of the inspection object H at a low voltage and a high voltage of the X-ray tube voltage larger and making the SN ratios at the low voltage and the high voltage of the X-ray tube voltage as equal as possible in consideration of the quality of the X-ray output from the X-ray tube and passing through the X-ray filter 53 and the energy detection distribution of the two-dimensional X-ray detector 7 (X-ray detector). The X-ray quality can be made suitable or more optimal by the X-ray imaging condition. The simulation execution unit 321 judges whether or not the low X-ray tube voltage and the high X-ray tube voltage derived by the simulation satisfy, for example, a predetermined condition related to an SNR (noise ratio) in which SN ratios at the low voltage and the high voltage of the X-ray tube voltage are made as equal as possible, and determines the X-ray imaging condition suitable for inspecting the inspection object H on the basis of on the judgement result. The predetermined condition is, for example, a condition in which each of the SNRs (noise ratios) at the low X-ray tube voltage and the high X-ray tube voltage derived by simulation is equal to or less than a predetermined value. Alternatively, the simulation execution unit 321 may derive a dual energy (DE) ratio between a high X-ray tube voltage value (high energy X-ray tube voltage value) and a low X-ray tube voltage value (low energy X-ray tube voltage value) on the basis of the physical quantity and the physical property information of the inspection object H which are input factors, and perform an optimization simulation such that the DE ratio increases. On the basis of the simulation result by the simulation execution unit 321, the filter characteristic determination unit 322 determines the filter characteristic of each of the high-energy and low-energy X-ray filters 53. On the basis of the simulation result by the simulation execution unit 321, the X-ray tube voltage determination unit 323 determines the X-ray tube voltage value of each of the high-energy and low-energy X-ray tubes 51. The X-ray imaging condition determination unit 32 may determine the X-ray imaging condition of X-rays of each of the two types of X-ray energies by determining the X-ray tube voltage value, the X-ray tube current value, the imaging time, and the X-ray filter 53 of X-rays of each of the two types of X-ray energies on the basis of the inspection object information and the X-ray characteristic information of the X-ray spectrum, the X-ray filters 53, and the two-dimensional X-ray detector 7 (X-ray detector) acquired by the acquisition unit 31.

The X-ray quality changes according to the tube voltage value of the X-ray tube 51 or the filter characteristic of the X-ray filter 53. Therefore, by determining the tube voltage value of the X-ray tube 51 and the filter characteristic of the X-ray filter 53 on the basis of the simulation result, it is possible to determine the X-ray imaging condition to be the quality of the X-ray. The X-ray imaging condition determination unit 32 outputs, to the output unit 33, information on the determined X-ray imaging condition including the filter characteristic and the X-ray tube voltage value.

The output unit 33 generates information on control parameters for controlling the X-ray generation device 5 on the basis of the information on the X-ray imaging condition acquired from the X-ray imaging condition determination unit 32, and outputs the information on the control parameters to the control controller 6. The information on the X-ray imaging condition includes information on the filter characteristic and the X-ray tube voltage value, and the output unit 33 generates information on the control parameters on the basis of the filter characteristic and the X-ray tube voltage value, and outputs the information to the control controller 6.

On the basis of the control parameters output from the output unit 33, the control controller 6 performs control related to setting of the tube voltage value of the X-ray tube 51 and setting of the filter characteristic by changing or adjusting the X-ray filter 53. Alternatively, the information on the X-ray imaging condition including the filter characteristic and the X-ray tube voltage value may be output to the control controller 6, and the control controller 6 may output the control parameters generated on the basis of the filter characteristic and the X-ray tube voltage value to the X-ray tube controller 54 and the X-ray filter 53 to control the X-ray tube 51 and the X-ray filter 53.

Although the central processing unit 3 of the operation console 2 has been described, the processing may be performed by another controller such as the control controller 6 without being limited thereto. Alternatively, a device group having a function of information calculation processing such as the central processing unit 3, the control controller 6, and the X-ray tube controller 54 may operate as a series of functional units in cooperation. Alternatively, these functional units may be realized by an external server communicably connected to the central processing unit 3 of the operation console 2 via an external network such as the Internet, and the central processing unit 3 of the operation console 2 may acquire a processing result by the external server and function as a series of functional units on the basis of the acquired processing result.

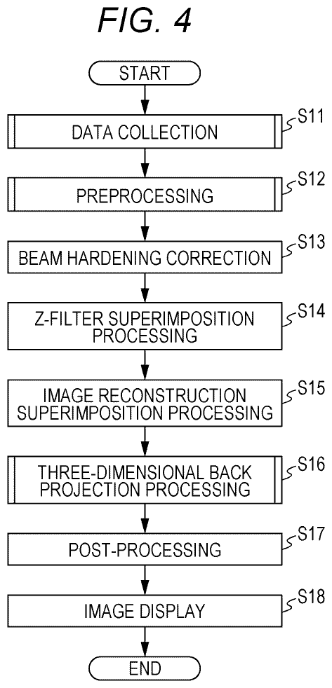

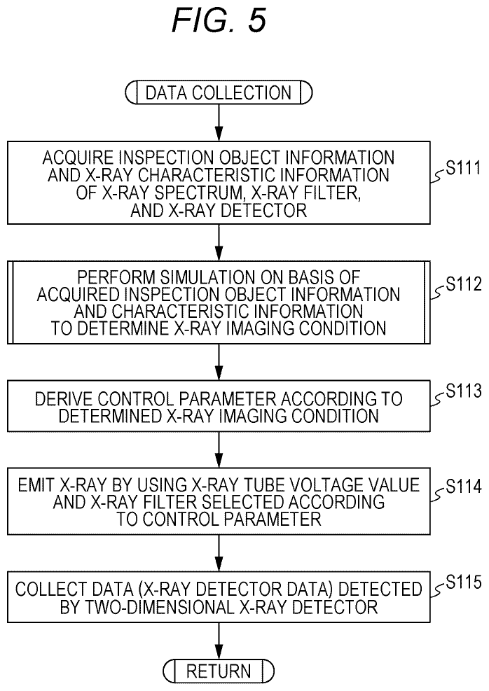

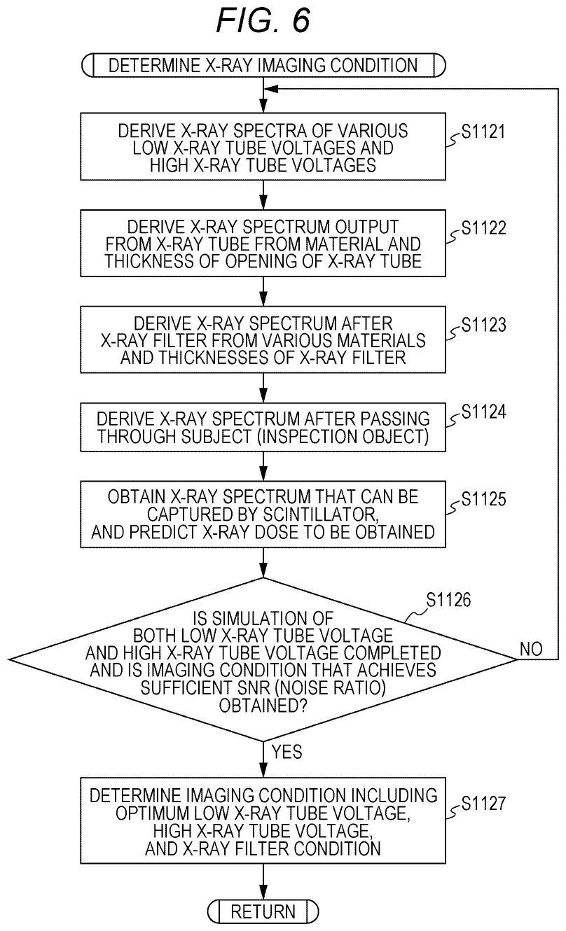

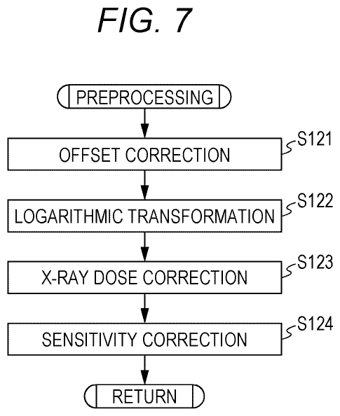

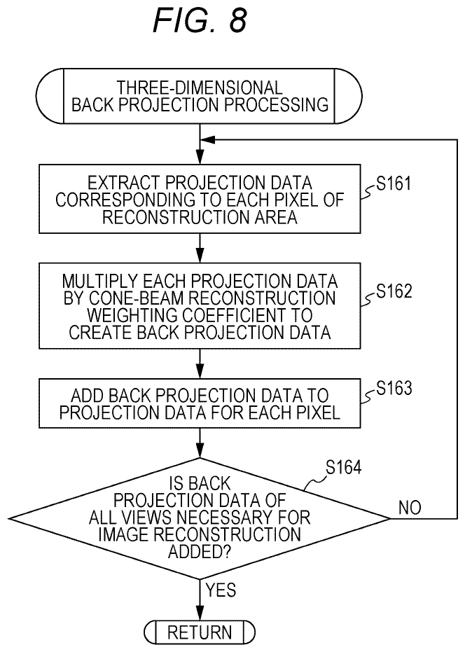

FIG. 4 is a flowchart illustrating a schematic operation of the X-ray CT apparatus 1. FIG. 5 is a flowchart illustrating details of data collection (simulation) in the schematic operation of the X-ray CT apparatus 1. FIG. 6 is a flowchart illustrating details of determination (simulation) of the X-ray imaging condition in the data collection of the X-ray CT apparatus 1. FIG. 7 is a flowchart illustrating details of preprocessing in the schematic operation of the X-ray CT apparatus 1. FIG. 8 is a flowchart illustrating three-dimensional back projection processing in the schematic operation of the X-ray CT apparatus 1. The X-ray CT apparatus 1 starts the processing or operation of the flowchart on the basis of, for example, instruction data including an operation instruction input by the operation console 2.

The X-ray CT apparatus 1 performs data collection (S11). The processing related to the data collection is executed by the following flow illustrated in FIG. 5 as subroutine processing, for example.

The X-ray CT apparatus 1 acquires inspection object information and X-ray characteristic information of the X-ray spectrum, the X-ray filters 53, and the two-dimensional X-ray detector 7 (X-ray detector) (S111). The X-ray CT apparatus 1 acquires the inspection object information of the inspection object H such as image data of the inspection object H output from the imaging unit 10, information on the inspection object H input from the input device 21, or the scout image of the inspection object H. Furthermore, the X-ray CT apparatus 1 acquires the X-ray characteristic information of the X-ray spectrum, the X-ray filters 53, and the two-dimensional X-ray detector 7 (X-ray detector).

The X-ray CT apparatus 1 performs simulation on the basis of the acquired inspection object information and X-ray characteristic information to determine the X-ray imaging condition (S112). The processing related to determination of the X-ray imaging condition is performed by the following flow illustrated in FIG. 6 as subroutine processing, for example.

The X-ray CT apparatus 1 derives the X-ray spectra of various low X-ray tube voltages and high X-ray tube voltages (S1121). The X-ray CT apparatus 1 derives the X-ray spectra of various low X-ray tube voltages and high X-ray tube voltages by, for example, measuring the X-ray spectra with an X-ray flat panel including a scintillator and photodiodes. Alternatively, the X-ray CT apparatus 1 may obtain the X-ray spectra of various low X-ray tube voltages and high X-ray tube voltages by simulation.

The X-ray CT apparatus 1 derives the X-ray spectrum output from the X-ray tube from the material and thickness of the opening of the X-ray tube (S1122). The X-ray CT apparatus 1 derives the X-ray spectrum after the X-ray filter 53 (after passing through the X-ray filter 53) from various materials and thicknesses of the X-ray filter 53 (S1123). The X-ray CT apparatus 1 refers to, for example, the storage device 24 to acquire the material and thickness of the opening of the X-ray tube and various materials and thicknesses of the X-ray filter 53 stored in the storage device 24. The X-ray CT apparatus 1 derives the X-ray spectrum on the basis of the acquired information.

The X-ray CT apparatus 1 derives the X-ray spectrum after passing through the subject (inspection object) (S1124). The X-ray CT apparatus 1 obtains the X-ray spectrum that can be captured by the scintillator, and predicts an X-ray dose to be obtained (S1125). For example, the X-ray CT apparatus 1 obtains the X-ray spectrum that can be captured by the scintillator included in the X-ray flat panel, and predicts an X-ray dose to be obtained.

The X-ray CT apparatus 1 judges whether or not the simulation of both the low X-ray tube voltage and the high X-ray tube voltage is completed and the imaging condition that achieves a sufficient SNR (noise ratio) is obtained (S1126). The X-ray CT apparatus 1 judges whether or not the low X-ray tube voltage and the high X-ray tube voltage derived by the simulation satisfy, for example, a predetermined condition related to the SNR (noise ratio). The predetermined condition is, for example, a condition in which each of the SNRs (noise ratios) at the low X-ray tube voltage and the high X-ray tube voltage derived by simulation is equal to or less than a predetermined value. In a case where an imaging condition that achieves a sufficient SNR (noise ratio) cannot be obtained (S1126: NO), the X-ray CT apparatus 1 performs loop processing to execute S1121 again. In a case where the imaging condition that achieves a sufficient SNR (noise ratio) is not obtained by the simulation, in performing the loop processing, the X-ray CT apparatus 1 (central processing unit 3) may perform iteration processing in which setting values (input factors) in performing the simulation is changed by every predetermined number and repeats the simulation. Alternatively, when simulating a low X-ray tube voltage and a high X-ray tube voltage, the X-ray CT apparatus 1 may derive a dual energy (DE) ratio between a high X-ray tube voltage value (high energy X-ray tube voltage value) and a low X-ray tube voltage value (low energy X-ray tube voltage value), and perform an optimization simulation such that the DE ratio increases.

In a case where an imaging condition that achieves a sufficient SNR (noise ratio) is obtained (S1126: YES), the X-ray CT apparatus 1 determines the imaging condition including the optimum low X-ray tube voltage, the optimum high X-ray tube voltage, and X-ray filter conditions (S1127). After executing the processing in S1121, the X-ray CT apparatus 1 executes the processing in S113. The X-ray CT apparatus 1 is not limited to the case of performing processing in and after S113 after executing the processing in S1121. After executing the processing in S1121, the X-ray CT apparatus 1 performs data collection and imaging at 80 kV and 140 kV to reconstruct a dual energy image. Furthermore, the X-ray CT apparatus 1 may display the reconstructed dual energy image to display a monochromatic tomographic image (monochromatic image), a water density image, an iodine density image, and the like.

The X-ray CT apparatus 1 derives the control parameters according to the determined X-ray imaging condition (S113). The X-ray CT apparatus 1 determines the filter characteristic of each of the high energy and low energy X-ray filters 53 and the X-ray tube voltage value of each of the high energy and low energy X-ray tubes 51 to be the X-ray imaging condition of the simulation result, and derives the control parameters for controlling the X-ray generation device 5 on the basis of the determined filter characteristics and X-ray tube voltage values. The series of processing from S111 to S113 may be performed by, for example, the central processing unit 3 of the operation console 2 included in the X-ray CT apparatus 1. Alternatively, the central processing unit 3 and the control controller 6 may perform the series of processing in cooperation with each other.

The X-ray CT apparatus 1 emits X-rays by using the X-ray tube voltage values and the X-ray filters 53 selected according to the control parameters (S114). The X-ray CT apparatus 1 selects or sets the X-ray tube voltage values and the X-ray filters 53 on the basis of the derived control parameters, and emits X-rays under the set condition. The X-ray CT apparatus 1 collects data (X-ray detector data) detected by the two-dimensional X-ray detector 7 (S115).

The X-ray CT apparatus 1 performs preprocessing (S12). The processing related to the preprocessing is performed by the following flow illustrated in FIG. 7 as subroutine processing, for example. The X-ray CT apparatus 1 performs offset correction (S121). The X-ray CT apparatus 1 performs logarithmic transformation (S122). The X-ray CT apparatus 1 performs X-ray dose correction (S123). The X-ray CT apparatus 1 performs sensitivity correction (S124). The preprocessing includes the offset correction, the logarithmic transformation, the X-ray dose correction, and the sensitivity correction. The X-ray CT apparatus 1 performs preprocessing on the X-ray detector data and converts the X-ray detector data into projection data.

The X-ray CT apparatus 1 performs beam hardening correction (S13). The X-ray CT apparatus 1 performs beam hardening correction on the preprocessed projection data.

The X-ray CT apparatus 1 performs Z-filter superimposition processing (S14). The X-ray CT apparatus 1 performs the Z-filter superimposition processing of applying a filter in the column direction (Z direction) to the projection data subjected to the beam hardening correction.

The X-ray CT apparatus 1 performs image reconstruction superimposition processing (S15). The X-ray CT apparatus 1 performs, for example, Fourier transform, multiplication by a reconstruction function, and inverse Fourier transform to perform reconstruction function superimposition processing.

The X-ray CT apparatus 1 performs three-dimensional back projection processing (S16). The X-ray CT apparatus 1 performs the three-dimensional back projection processing on the projection data subjected to the reconstruction function superimposition processing to obtain back projection data. In the present embodiment, it is assumed that helical scan is performed, and an image to be reconstructed is three-dimensionally reconstructed on a plane perpendicular to the Z-axis and the XY plane. It is assumed that the following reconstruction area is parallel to the XY plane. The processing related to the three-dimensional back projection processing is performed, for example, by the following flow illustrated in FIG. 8 as subroutine processing.

The X-ray CT apparatus 1 extracts projection data corresponding to each pixel of the reconstruction area (S161). The X-ray CT apparatus 1 focuses on one view among all views (that is, the view for 360 degrees or the view for “180 degrees +fan angle”) necessary for image reconstruction of the tomographic image, and extracts projection data corresponding to each pixel of the reconstruction area.

The X-ray CT apparatus 1 multiplies each projection data by a cone-beam reconstruction weighting coefficient to create back projection data (S162). The X-ray CT apparatus 1 multiplies the projection data by the cone-beam reconstruction weighting coefficient to create back projection data.

The X-ray CT apparatus 1 adds the back projection data to the projection data for each pixel (S163). The X-ray CT apparatus 1 adds the projection data to the back projection data cleared in advance for each pixel.

The X-ray CT apparatus 1 judges whether or not the back projection data of all the views necessary for the image reconstruction is added (S164). The X-ray CT apparatus 1 judges whether or not back projection data addition processing has been performed for all the views (that is, the view for 360 degrees or the view for “180 degrees +fan angle”) necessary for image reconstruction of a tomographic image. In a case where the processing has not been performed for all the views (S164: NO), loop processing is performed to execute the processing in S161 again. By performing the loop processing, the X-ray CT apparatus 1 repeats the processing in S161 to S163 for all the views. In a case where the processing has been performed for all the views (S164: YES), the X-ray CT apparatus 1 executes the processing in S17.

The X-ray CT apparatus 1 performs post-processing (S17). The X-ray CT apparatus 1 performs post-processing such as image filter superimposition and CT value conversion on the back projection data to obtain a tomographic image.

The X-ray CT apparatus 1 performs image display (S18). The X-ray CT apparatus 1 displays the tomographic image obtained by performing the post-processing on the monitor 23. The schematic operation of the X-ray CT apparatus 1 indicated in the series of flows may be performed using, for example, the processing described in JP 5220374 B1, JP 5213016 B1, and JP 2007-20906 A.

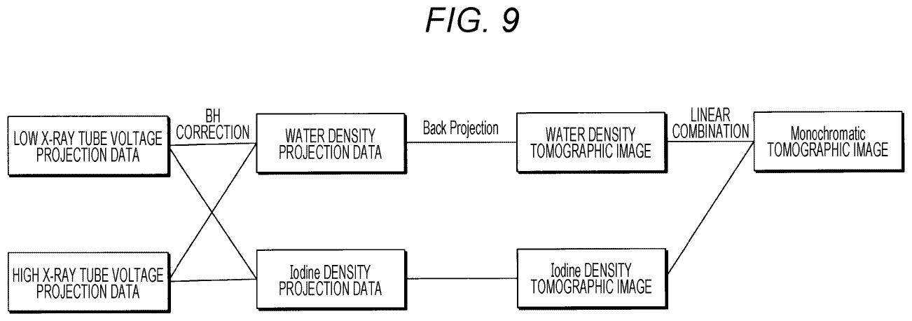

FIG. 9 is an explanatory diagram illustrating a flow of data processed in image reconstruction by dual energy imaging. The X-ray CT apparatus 1 performs processing of reconstructing a monochromatic tomographic image by performing dual energy imaging. Beam hardening (BH) correction is performed on each of projection data (high X-ray tube voltage projection data) at a high X-ray tube voltage and projection data (low X-ray tube voltage projection data) at a low X-ray tube voltage obtained by emitting two types of X-rays having different high and low X-ray tube voltage values. Thus, for example, in a case where the first substance is water and the second substance is iodine, water density projection data and iodine density projection data are generated. That is, a plurality of pieces of substance density projection data can be obtained.

By performing processing using filtered back projection on the water density projection data and the iodine density projection data, a water density tomographic image and an iodine density tomographic image are reconstructed. A monochromatic tomographic image is reconstructed by linearly combining the reconstructed water density tomographic image and the reconstructed iodine density tomographic image. Therefore, it is possible to reconstruct a dual energy X-ray image including at least one of a plurality of substance density tomographic images or a monochromatic tomographic image. The flow of data processed in the image reconstruction by the dual-energy imaging may be performed using, for example, the processing described in JP 5220374 B1, JP 5213016 B1, or JP 2012-245235 A.

According to the present embodiment, the X-ray CT apparatus 1 acquires inspection object information including the physical quantity and the physical property information of the inspection object H, and determines information on the X-ray imaging condition corresponding to the quality (X-ray quality) of X-rays suitable for the inspection object H on the basis of the acquired inspection object information. The X-ray CT apparatus 1 determines the information on the X-ray imaging condition by using the predetermined simulation method, so that the information on the X-ray imaging condition can efficiently be determined. The X-ray CT apparatus 1 may determine the quality (X-ray quality) of X-rays before and after the inspection object H when collecting the X-ray data of two types of energies emitted to the inspection object H. By determining the information on the X-ray imaging condition that provides the X-ray quality suitable for the inspection object H in this manner, the X-ray filters 53 can be optimized such that the DE ratio at the high X-ray tube voltage and the low X-ray tube voltage increases according to the physical quantity such as the size of the inspection object H and the physical property information such as the material of the inspection object H, and the dual energy imaging tomographic image with the optimum SNR (noise ratio) can be collected, reconfigured, and displayed.

According to the present embodiment, the X-ray CT apparatus 1 determines the X-ray imaging condition by determining the filter characteristic due to the type, thickness, or the like of each of the X-ray filter 53 having the high X-ray tube voltage and the X-ray filter 53 having the low X-ray tube voltage used in the dual energy imaging. Therefore, in performing the dual energy imaging, the X-ray filters 53 providing the X-ray quality suitable for the inspection object H can efficiently be selected. Furthermore, the X-ray CT apparatus 1 determines information on the X-ray imaging condition by determining the tube voltage value of the high X-ray tube voltage and the tube voltage value of the low X-ray tube voltage used in the dual-energy imaging. Therefore, in performing the dual energy imaging, it is possible to efficiently select each tube voltage value serving as an X-ray imaging condition suitable for the inspection object H.

### Second Embodiment

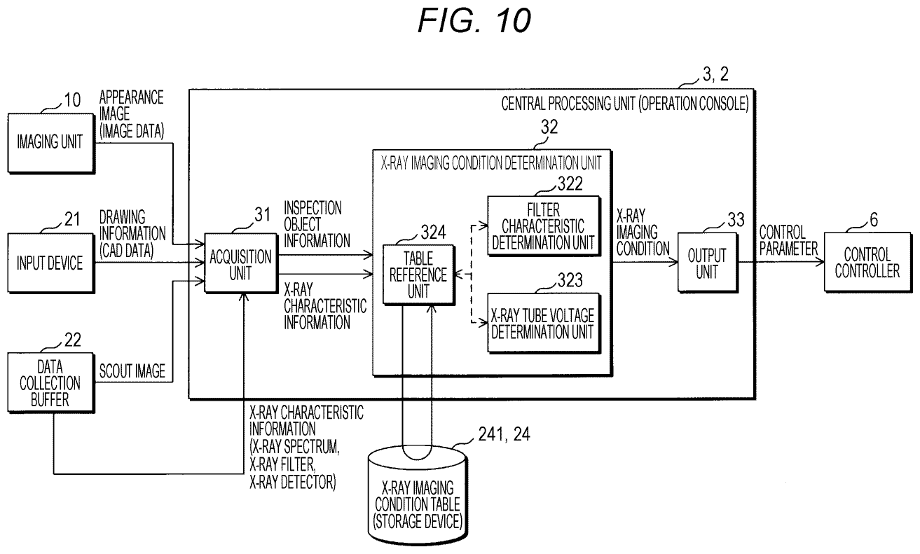

FIG. 10 is a functional block diagram exemplifying functional units included in an X-ray CT apparatus 1 (central processing unit 3) according to a second embodiment. Similarly to the first embodiment, a central processing unit 3 of the X-ray CT apparatus 1 according to the second embodiment functions as an acquisition unit 31, an X-ray imaging condition determination unit 32, and an output unit 33 by executing a program stored in a storage device 24. The acquisition unit 31 and the output unit 33 according to the second embodiment have configurations similar to those of the acquisition unit 31 and the output unit 33 according to the first embodiment.

The X-ray imaging condition determination unit 32 according to the second embodiment includes a table reference unit 324, a filter characteristic determination unit 322, and an X-ray tube voltage determination unit 323. On the basis of inspection object information output from the acquisition unit 31, the table reference unit 324 refers to an X-ray imaging condition table 241 stored in the storage device 24, and derives the X-ray tube voltage values (low tube voltage value and high tube voltage value) and the filter characteristic (filter type and filter thickness) corresponding to the physical quantity and the physical property information included in the inspection object information. The filter characteristic determination unit 322 and the X-ray tube voltage determination unit 323 determines the filter characteristic and the X-ray tube voltage values on the basis of the derivation result of the table reference unit 324, and output the filter characteristic and the X-ray tube voltage values to the output unit 33.

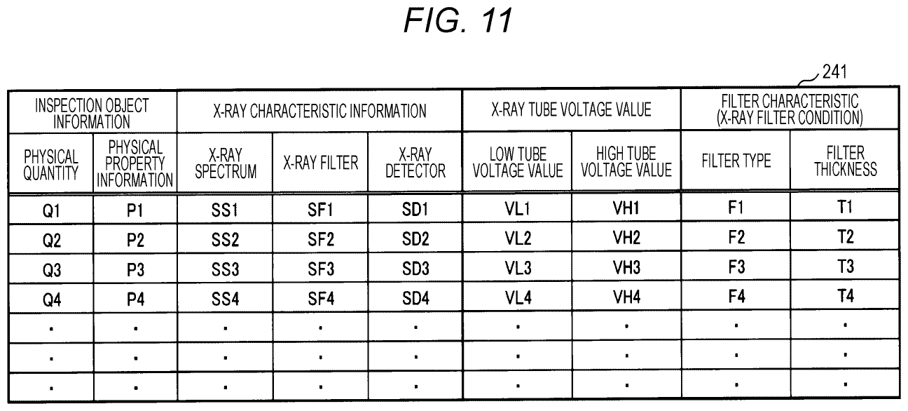

FIG. 11 is an explanatory diagram exemplifying the X-ray imaging condition table (lookup table) 241. The X-ray imaging condition table 241 is stored in the storage device 24 and corresponds to a lookup table that is referred to by the central processing unit 3 in the processing of determining the X-ray imaging condition. The X-ray imaging condition table 241 may be configured as, for example, an information table based on the simulation in the first embodiment. The X-ray imaging condition table 241 is not limited to the case of being stored in the storage device 24, and may be stored in another computer or storage device to which an operation console 2 is communicably connected, and the central processing unit 3 may refer to the X-ray imaging condition table 241 by accessing the other computer or the like from the operation console 2 (central processing unit 3).

The X-ray imaging condition table 241 includes, as management items (metadata), for example, a physical quantity and physical property information which are items related to the inspection object information, a low tube voltage value and a high tube voltage value which are items related to X-ray tube voltage values, and a filter type and a filter thickness which are items related to a filter characteristic. Furthermore, the X-ray imaging condition table 241 includes, for example, items related to the X-ray characteristic information of an X-ray spectrum, an X-ray filter 53, and a two-dimensional X-ray detector 7 (X-ray detector) as the management items (metadata) related to X-ray characteristic information.

The physical quantity stores information related to the size or shape dimensions of an inspection object H. The physical property information stores information on the material of the inspection object H. The X-ray characteristic information of the X-ray spectrum, the X-ray filter 53, and the two-dimensional X-ray detector 7 (X-ray detector) stores X-ray characteristic information specified in the X-ray spectrum, the X-ray filter 53, and the two-dimensional X-ray detector 7 (X-ray detector). The inspection object information and the X-ray characteristic information correspond to input factors for determining (deriving) the X-ray imaging condition including the X-ray tube voltage values and the filter characteristic.

The low tube voltage value stores a low X-ray tube voltage value suitable for inspecting the inspection object H of the corresponding inspection object information. The high tube voltage value stores a high X-ray tube voltage value suitable for inspecting the inspection object H of the corresponding inspection object information. The filter type stores information on the filter type such as the material of each of the X-ray filters 53 (the X-ray filter 53 through which high-energy X-rays pass and the X-ray filter 53 through which low-energy X-rays pass) suitable for inspecting the inspection object H of the corresponding inspection object information. The filter thickness stores information on the thickness dimension of each of the X-ray filters 53 (the X-ray filter 53 through which high-energy X-rays pass and the X-ray filter 53 through which low-energy X-rays pass) suitable for inspecting the inspection object H of the corresponding inspection object information.

The high X-ray tube voltage value, the low X-ray tube voltage value, the filter type, and the filter thickness, which are derived by referring to the X-ray imaging condition table 241, are combined to obtain the X-ray quality suitable for the inspection object H specified by the combination of the X-ray characteristic information of the X-ray spectrum, the X-ray filters 53, and the two-dimensional X-ray detector 7 (X-ray detector), and the inspection object information.

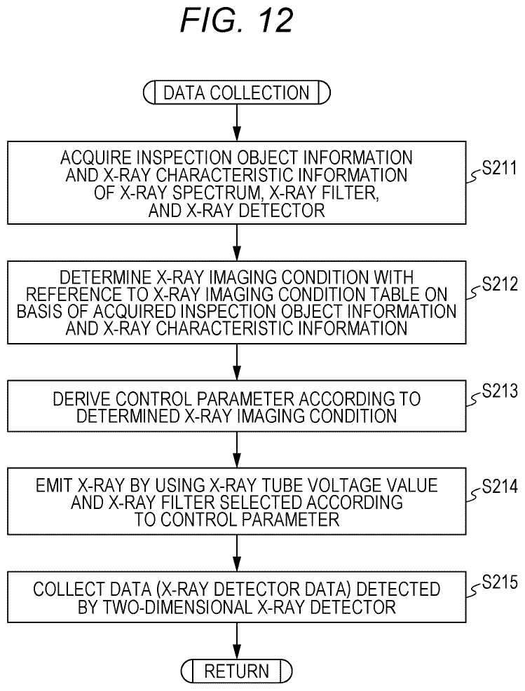

FIG. 12 is a flowchart illustrating details of data collection (lookup table) in the schematic operation of the X-ray CT apparatus 1. The X-ray CT apparatus 1 according to the second embodiment performs the processing from S11 to S18 similarly to the first embodiment. In the X-ray CT apparatus 1 according to the second embodiment, the processing related to the data collection in S11 is performed by the following flow illustrated in FIG. 12 as subroutine processing, for example.

The X-ray CT apparatus 1 acquires inspection object information and X-ray characteristic information of the X-ray spectrum, the X-ray filters 53, and the two-dimensional X-ray detector 7 (X-ray detector) (S211). The X-ray CT apparatus 1 acquires inspection object information similarly to the first embodiment.

The X-ray CT apparatus 1 determines the X-ray imaging condition with reference to the X-ray imaging condition table 241 on the basis of the acquired inspection object information and X-ray characteristic information (S212). On the basis of the inspection object information and X-ray characteristic information output from the acquisition unit 31, the X-ray CT apparatus 1 refers to the X-ray imaging condition table 241 stored in the storage device 24, and derives an X-ray imaging condition including the X-ray tube voltage values (low tube voltage value and high tube voltage value) and the filter characteristic (filter type and filter thickness) corresponding to the X-ray characteristic information and the physical quantity and physical property information included in the inspection object information. The X-ray quality is determined on the basis of the derived X-ray tube voltage values (low tube voltage value and high tube voltage value) and the filter characteristic (filter type and filter thickness).

The X-ray CT apparatus 1 derives control parameters according to the determined X-ray imaging condition (S213). The X-ray CT apparatus 1 emits X-rays by using the X-ray tube voltage values and the X-ray filters 53 selected according to the control parameter (S214). The X-ray CT apparatus 1 collects data (X-ray detector data) detected by the two-dimensional X-ray detector 7 (S215). The X-ray CT apparatus 1 performs the processing from S213 to S215 similarly to S113 to S115 in the first embodiment.

According to the present embodiment, since the X-ray CT apparatus 1 refers to the X-ray imaging condition table 241 (lookup table) stored in advance in a predetermined storage area to determine (derive) the X-ray imaging condition including the X-ray tube voltage values (low tube voltage value and high tube voltage value) and the filter characteristic (filter type and filter thickness) which are determination factors for emitting X-rays of the suitable X-ray quality, the X-ray CT apparatus 1 can efficiently determine the X-ray imaging condition.

In the present embodiment, the X-ray CT apparatus 1 determines the X-ray imaging condition by using the X-ray imaging condition table 241, on the basis of the acquired inspection object information and X-ray characteristic information, but the X-ray CT apparatus 1 is not limited thereto. The X-ray CT apparatus 1 may determine the X-ray imaging condition by using a judgment algorithm included in a program stored in advance in a predetermined storage area such as the storage device 24, on the basis of the acquired inspection object information and X-ray characteristic information. The program including the judgment algorithm is configured to output an imaging condition that achieves a sufficient SNR (noise ratio) with respect to the inspection object by using the inspection object information and the X-ray characteristic information as input factors. Alternatively, the X-ray CT apparatus 1 may determine the X-ray imaging condition by using a learning model stored in advance in a predetermined storage area such as the storage device 24, on the basis of the acquired inspection object information and X-ray characteristic information. The learning model is trained to output an imaging condition that achieves a sufficient SNR (noise ratio) with respect to the inspection object by receiving the inspection object information and the X-ray characteristic information as input. For example, the learning model may be a neural network (NN) such as a convolutional neural network (CNN), the RCNN, or the like that handles as input data, image data of an inspection object output from an imaging unit 10 as inspection object information, or may be a learning model constructed by another learning algorithm such as a support vector machine (SVM), a Bayesian network, or a regression tree, without being limited to the NN.

The embodiments disclosed herein are considered to be illustrative in all respects and not restrictive. The technical features described in the embodiments can be combined with each other, and the scope of the present invention is intended to include all modifications within the scope of the claims and the scope equivalent to the claims.

What is claimed is:

1. An X-ray CT apparatus comprising an X-ray generation device and an X-ray detector configured to detect an X-ray emitted from the X-ray generation device and passing through an inspection object, and collecting X-ray projection data of at least two types of X-ray energies to reconstruct a dual energy image, the X-ray CT apparatus further comprising:
an acquisition unit configured to acquire inspection object information including a physical quantity and physical property information of the inspection object, and X-ray characteristic information of an X-ray spectrum, an X-ray filter, and the X-ray detector; and
an X-ray imaging condition determination unit configured to determine each of X-ray imaging conditions for collecting the X-ray projection data of the at least two types of X-ray energies emitted from the X-ray generation device, on a basis of the inspection object information and the X-ray characteristic information of the X-ray spectrum, the X-ray filter, and the X-ray detector acquired by the acquisition unit.

2. The X-ray CT apparatus according to claim 1,
wherein the X-ray imaging condition determination unit determines the each of the X-ray imaging conditions for collecting the X-ray projection data of the at least two types of energies emitted from the X-ray generation device by using a simulation method determined in advance or using a method of referring to an information table based on a simulation, on a basis of the inspection object information and the X-ray characteristic information of the X-ray spectrum, the X-ray filter, and the X-ray detector acquired by the acquisition unit.

3. The X-ray CT apparatus according to claim 1,
wherein the X-ray generation device includes X-ray filters through which X-rays of the at least two types of X-ray energies pass, respectively, to adjust X-ray quality, and
the X-ray imaging condition determination unit determines an X-ray imaging condition of an X-ray of each of the at least two types of X-ray energies by determining a filter characteristic of each of the X-ray filters, on a basis of the inspection object information and the X-ray characteristic information of the X-ray spectrum, the X-ray filter, and the X-ray detector acquired by the acquisition unit.

4. The X-ray CT apparatus according to claim 1,
wherein the X-ray imaging condition determination unit determines an X-ray imaging condition of an X-ray of each of the at least two types of X-ray energies by determining an X-ray tube voltage value, an X-ray tube current value, imaging time, and an X-ray filter of the X-ray of each of the at least two types of X-ray energies, on a basis of the inspection object information and the X-ray characteristic information of the X-ray spectrum, the X-ray filter, and the X-ray detector acquired by the acquisition unit.

5. The X-ray CT apparatus according to claim 1,
wherein the acquisition unit that acquires the inspection object information including the physical quantity and the physical property information of the inspection object acquires the inspection object information on a basis of at least one of an appearance image, a scout image, or drawing information of the inspection object.

6. The X-ray CT apparatus according to claim 1, further comprising an image reconstruction unit configured to reconstruct an X-ray dual energy tomographic image on a basis of X-ray projection data detected by the X-ray detector,
wherein the image reconstruction unit obtains a plurality of pieces of substance density projection data on a basis of X-ray projection data of the at least two types of X-ray energies that has been collected, and reconstructs an X-ray dual energy tomographic image including at least one of a plurality of substance density tomographic images or a monochromatic tomographic image.

7. The X-ray CT apparatus according to claim 1,
wherein the X-ray imaging condition determination unit determines the each of the X-ray imaging conditions for collecting the X-ray projection data of the at least two types of X-ray energies emitted from the X-ray generation device by using a lookup table, a judgement algorithm, or a learning model stored in advance in a predetermined storage area, on a basis of the inspection object information and the X-ray characteristic information of the X-ray spectrum, the X-ray filter, and the X-ray detector acquired by the acquisition unit.

8. A non-transitory computer-readable recording medium storing a program causing a computer to execute a process comprising:
acquiring inspection object information including a physical quantity and physical property information of an inspection object to be an object to be inspected by X-rays of at least two types of X-ray energies emitted from an X-ray generation device, and X-ray characteristic information of an X-ray spectrum, an X-ray filter, and an X-ray detector; and
determining each of X-ray imaging conditions for collecting X-ray projection data of the at least two types of X-ray energies emitted from the X-ray generation device on a basis of the inspection object information and the X-ray characteristic information of the X-ray spectrum, the X-ray filter, and the X-ray detector that have been acquired.

9. An information processing method causing a computer to execute a process comprising:
acquiring inspection object information including a physical quantity and physical property information of an inspection object to be an object to be inspected by X-rays of at least two types of X-ray energies emitted from an X-ray generation device, and X-ray characteristic information of an X-ray spectrum, an X-ray filter, and an X-ray detector; and
determining each of X-ray imaging conditions for collecting X-ray projection data of the at least two types of X-ray energies emitted from the X-ray generation device on a basis of the inspection object information and the X-ray characteristic information of the X-ray spectrum, the X-ray filter, and the X-ray detector that have been acquired.
